(19) United States
(12) Patent Application Publication
(10) Pub. No.: US 2007/0107135 A1
(43) Pub. Date: May 17, 2007

(54) Method for the production of leather by using polymers

(75) Inventors: Stephan Hüffer, Ludwigshafen (DE); Gerhard Wolf, Ketsch (DE); Matthias Kluglein, Poppenhausen (DE); Stefan Becker, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/565,512

(22) PCT Filed: Jul. 3, 2004
(86) PCT No.: PCT/EP04/07270

§ 371 Date: Jun. 28, 2006

(30) Foreign Application Priority Data
Jul. 23, 2003 (DE) 103 33 749.0

(51) Int. Cl. C14C 1/00

(52) U.S. Cl. 8/94.15

(57) ABSTRACT

Leathers are produced by a process wherein pelts, pickled pelts or semifinished products are treated with at least one polymer which is obtainable by copolymerizing (A) at least one ethylenically unsaturated mono- or dicarboxylic acid of 3 to 8 carbon atoms or at least one anhydride derived from a mono- or dicarboxylic acid of 3 to 8 carbon atoms, (B) at least one vinylaromatic compound,
(C) at least one alkoxylated unsaturated ether of the formula I 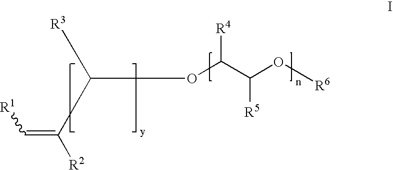 (D) optionally further monoethylenically unsaturated monomers, where, in formula 1, the variables are defined as follows:
R¹, R² and R³ are identical or different and are selected from C₁-C₄-alkyl and hydrogen;
R⁴ and R⁵ are in each case identical or different and are selected from C₁-C₄-alkyl and hydrogen;
R⁶ is selected from hydrogen, SO₃M, PO₃M₂, C₁-C₃₀-alkyl, CO—H (formyl), CO—C₁-C₂₀-alkyl and CO—C₆-C₁₄-aryl,
M is an alkali metal or NH₄⁺ or CH₃, n is an integer from 3 to 100 and y is an integer from 0 to 10.

The present invention relates to a process for the production of leather, wherein pelts, pickled pelts or semifinished products are treated with a polymer which is obtainable by copolymerizing
(A) at least one ethylenically unsaturated mono- or dicarboxylic acid of 3 to 8 carbon atoms or at least one anhydride derived from a mono- or dicarboxylic acid of 3 to 8 carbon atoms,
(B) at least one vinylaromatic compound,
(C) at least one alkoxylated unsaturated ether of the formula I 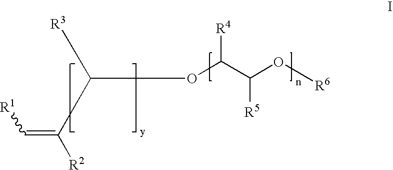
(D) optionally further monoethylenically unsaturated monomers,
where, in formula 1, the variables are defined as follows:
R¹, R² and R³ are identical or different and are selected from C₁-C₄-alkyl and hydrogen;
R⁴ and R⁵ are in each case identical or different and are selected from C₁-C₄-alkyl and hydrogen;
R⁶ is selected from hydrogen, SO₃M, PO₃M₂, C₁-C₃₀-alkyl, CO—H (formyl), CO—C₁-C₂₀-alkyl and CO—C₆-C₁₄-aryl,
M is an alkali metal or NH₄⁺ or CH₃,
n is an integer from 3 to 100 and
y is an integer from 0 to 10.

For the production of leather, polymers can be used in the pretanning, main tanning and retanning. By using polymers in the pretanning, it is possible in many cases completely or at least partly to dispense with chromium compounds. The choice of the polymers can influence the properties of the leather product. Various proposals are made in the literature regarding the choice of the polymers.

WO 01/96007 discloses water-soluble copolymers which are prepared by copolymerizing (meth)acrylic acid or maleic monoesters, an alkyl-endcapped alkoxylated monoester and optionally a dicarboxylic acid and optionally styrene, and their use as dispersants for pigments, for example CaCO₃, is described.

EP-A 0 628 085 describes the use of copolymers of maleic anhydride and optionally a second monomer, for example styrene, isobutene or vinyl acetate, the copolymers being reacted with alkoxylated alcohols before being used for retanning and filling.

U.S. Pat. No. 5,646,225 and U.S. Pat. No. 5,728,777 disclose copolymers of styrene, methacrylic acid and monopropoxylated allyl alcohol and the use of the copolymers in solvent-based inks (U..S Pat. No. 5,728,777).

EP-A 0 792 377 discloses a process in which the tanning and, if required, also the pretanning are carried out by means of aldehydes or other reactive carbonyl compounds in the presence of polymers, for example maleic anhydride/a-olefin/styrene terpolymers (variant I). The leathers thus produced have good lightfastness and stability to heat yellowing. The tensile strength of the leathers thus produced is, however, still unsatisfactory.

However, the polymers mentioned in the prior art are not yet optimal for the treatment of, in particular soft leathers. For example, the leathers produced by the methods to date can be improved in their body, their grain characteristics and the surface properties. Furthermore, the distribution of the fats used in the retanning in the leather cross section is not yet optimal.

It is an object of the present invention to provide an improved process for the production of leather, which avoids the abovementioned weaknesses.

We have found that this object is achieved by the process defined at the outset. It starts from at least one of the polymers defined at the outset. Polymers defined at the outset comprise as monomers in the form of polymerized units:
(A) at least one ethylenically unsaturated mono- or dicarboxylic acid of 3 to 8 carbon atoms or at least one anhydride derived from a mono- or dicarboxylic acid of 3 to 8 carbon atoms. Examples of ethylenically unsaturated mono- or dicarboxylic acids of 3 to 8 carbon atoms are (meth)acrylic acid, maleic acid, fumaric acid and crotonic acid; acrylic acid is very particularly preferred.
   Examples of anhydrides derived from a mono- or dicarboxylic acid of 3 to 8 carbon atoms are maleic anhydride, itaconic anhydride, citraconic anhydride and methylenemalonic anhydride, preferably itaconic anhydride and maleic anhydride, very particularly preferably maleic anhydride.
   Mixed anhydrides are also suitable, for example the mixed anhydride of (meth)acrylic acid and acetic acid.
(B) at least one vinylaromatic compound, for example of the formula VIII 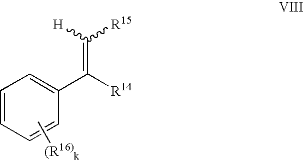
   where R¹⁴ and R¹⁵, independently of one another, are each hydrogen, methyl or ethyl, R¹⁶ is methyl or ethyl and k is an integer from 0 to 2; R¹⁴ and R¹⁵ are each preferably hydrogen and k is preferably 0.
   Preferably α-methylstyrene, very particularly preferably styrene, is used as (B).
(C) at least one alkoxylated unsaturated ether of the formula I 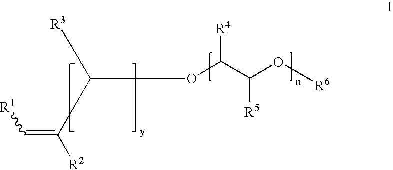
   where, in formula I, the variables are defined as follows:
R¹, R², and R³ are identical or different and are selected from C₁-C₄-alkyl, such as methyl, ethyl, n-propyl, isopropyl, n-butyl, isobutyl, sec-butyl and tert-butyl, particularly preferably methyl, and hydrogen,
R⁴ and R⁵ are in each case identical or different and are selected from C₁-C₄-alkyl, such as methyl, ethyl, n-propyl, isopropyl, n-butyl, isobutyl, sec-butyl and tert-butyl, particularly preferably methyl, and hydrogen,
R⁶ is selected from hydrogen,
   SO₃M, PO₃M₂,
   preferably organic radicals, such as
C₁-C₃₀-alkyl, preferably linear or branched, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl, n-hexadecyl, n-octadecyl or n-eicosyl, particularly preferably C₁-C₄-alkyl, such as methyl, ethyl, n-propyl, isopropyl, n-butyl, isobutyl, sec-butyl or tert-butyl,
   CO—H (formyl) or CO—C₁-C₂₀-alkyl, particularly preferably acetyl, propionyl, n-butyryl, n-stearyl or n-lauryl,
   CO—C₆-C₁₄-aryl, for example α-naphthoyl, β-naphthoyl or preferably benzoyl CO—C₆H₅,
M is an alkali metal, in particular sodium or potassium or NH₄⁺ or CH₃,
n is an integer from 3 to 100, preferably from 10 to 40, and
y is an integer from 0 to 10, preferably from 1 to 10, particularly preferably 1 or2.

Particularly preferably, R⁴ and R⁵ are each hydrogen.

Particularly preferably, R¹ and R³ are hydrogen, R² is selected from hydrogen and methyl, and y is 1.

Optionally, one or more further monoethylenically unsaturated monomers (D) can be incorporated in the form of polymerized units.

The monomer or monomers (D) which can optionally be incorporated in the form of polymerized units in the polymers used in the novel process differ from (A). Examples of preferred monomers (D) are:

ethylenically unsaturated C₃-C₈-carboxylic acid derivatives of the formula II

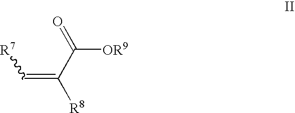

acrylamides of the formula III

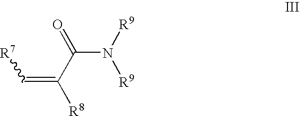

acyclic amides of the formula IV a and cyclic amides of the formula IV b

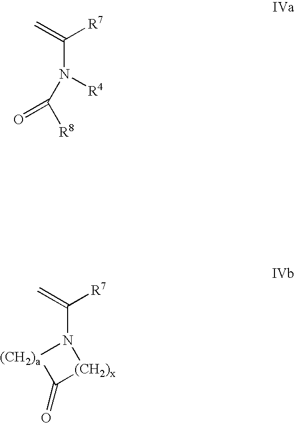

C₁-C₂₀-alkyl vinyl ethers, such as methyl vinyl ether, ethyl vinyl ether, n-propyl vinyl ether, isopropyl vinyl ether, n-butyl vinyl ether, isobutyl vinyl ether, 2-ethylhexyl vinyl ether or n-octadecyl vinyl ether,

N-vinyl derivatives of nitrogen-containing aromatic compounds, preferably N-vinylimidazole, 2-methyl-1-vinylimidazole, N-vinyloxazolidone, N-vinyltriazole, 2-vinylpyridine, 4-vinylpyridine, 4-vinylpyridine N-oxide, N-vinylimidazoline or N-vinyl-2-methylimidazoline,

alkoxylated unsaturated ethers of the formula V,

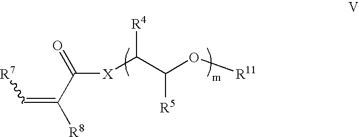

esters and amides of the formula VI,

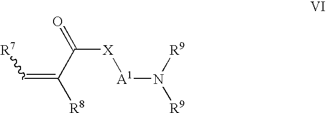

unsaturated esters of the formula VII

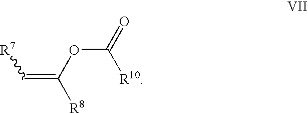

Monomers containing sulfonate, phosphate or phosphonate groups, for example vinylsulfonic acid and vinylphosphonic acid and compounds of the formula IX

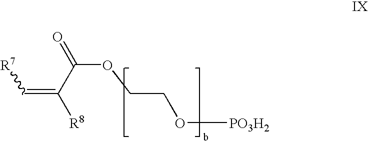

are furthermore suitable, it being possible for phosphate groups, sulfonate groups or phosphonate groups to be present if appropriate partly or completely in the form of alkali metal salts;

the variables being defined as follows:
R⁷, is selected from straight-chain and branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl,
   and in particular hydrogen;
R⁸ is selected from straight-chain or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl, in particular methyl,
   and in particular hydrogen;
R⁹ are identical or different and are branched or straight-chain C₁-C₂₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl, n-dodecyl and n-eicosyl, particularly preferably C₁-C₄-alkyl, such as methyl, ethyl, n-propyl, isopropyl, n-butyl, isobutyl, sec-butyl and tert-butyl,
   and particularly preferably hydrogen;
A¹ are identical or different and are C₂-C₆-alkylene, for example —CH₂—, —CH(CH₃)—, —(CH₂)₂—, —CH₂—CH(CH₃)—, —(CH₂)₃—, —CH₂—CH(C₂H₅)—, —(CH₂)₄—, —(CH₂)₅—, —(CH₂)₆—, preferably C₁-C₃-alkylene, in particular —(CH₂)₂—, —CH₂—CH(CH₃)— and —CH₂—CH(C₂H₅)—;
x is an integer from 2 to 6, preferably from 3 to 5;
a is an integer from 0 to 6, preferably from 0 to 2;
b is an integer from 1 to 40, preferably from 1 to 10;
m is an integer from 2 to 200, preferably from 10 to 40;
R¹⁰ and R¹¹ are identical or different and are selected from hydrogen and straight-chain and branched C₁-C₁₀-alkyl, straight-chain and branched C₁-C₁₀-alkyl being defined as above;
x is oxygen or N—R¹²;
R¹² is selected from straight-chain or branched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl, in particular hydrogen and methyl, and phenyl.

The other variables are defined as above.

Selected examples of compounds of the formula III are (meth)acrylamides, such as acrylamide, N-methylacrylamide, N,N-dimethylacrylamide, N-ethylacrylamide, N-propylacrylamide, N-tert-butylacrylamide, N-tert-octylacrylamide, N-undecylacrylamide and the corresponding methacrylamides.

Selected examples of compounds of the formula IV a are N-vinylcarboxamides, such as N-vinylformamide, N-vinyl-N-methylformamide, N-vinylacetamide and N-vinyl-N-methylacetamide; selected examples of typical compounds of the formula IV b are N-vinylpyrrolidone, N-vinyl-4-piperidone and N-vinyl-ε-caprolactam.

Selected examples of compounds of the formula VI are (meth)acrylates and (meth)acrylamides, such as N,N-dialkylaminoalkyl (meth)acrylates or N,N-dialkylaminoalkyl(meth)acrylamides; examples are N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, 2-(N, N-dimethylamino)ethylacrylamide,2-(N,N-dimethylamino)ethylmethacrylamide, 2-(N,N-diethylamino)ethylacrylamide, 2-(N,N-diethylamino)ethylmethacrylamide, 3-(N,N-dimethylamino)propylacrylamide and 3-(N,N-dimethylamino)propylmethacrylamide.

Selected examples of compounds of the formula VII are vinyl acetate, vinyl propionate, vinyl butyrate, vinyl 2-ethylhexanoate and vinyl laurate.

The following are very particularly preferably used as monomer (D): methyl acrylate, methyl methacrylate, acrylamide, vinyl n-butyl ether, vinyl isobutyl ether, N-vinylformamide, N-vinylpyrrolidone, 1-vinylimidazole, 4-vinylpyridine, vinylphosphonic acid and vinylsulfonic acid.

In an embodiment of the present invention, the monomers (A) to (D) are incorporated in he form of polymerized units as follows:
(A) from 2 to 50, preferably from 5 to 30, % by weight of at least one ethylenically unsaturated mono- or dicarboxylic acid of 3 to 8 carbon atoms or of at least one anhydride derived from a mono- or dicarboxylic acid of 3 to 8 carbon atoms,
(B) from 5 to 80, preferably from 8 to 50, % by weight of at least one vinylaromatic compound,
(C) from 10 to 90, preferably from 40 to 75, % by weight of at least one alkoxylated unsaturated ether of the formula I,
(D) from 0 to 20, preferably up to 10, % by weight of at least one further monomer,
the monomers being defined as above.

The preparation of the polymers used in the novel process can be carried out as follows. It is possible to copolymerize the monomers (A), (B), (C) and, if appropriate, (D) with one another by solution polymerization, precipitation polymerization or, preferably, in the absence of a solvent by mass polymerization. (A), (B), (C) and, if appropriate, (D) can be copolymerized in the form of random copolymers or as block copolymers.

Pressure and temperature conditions for a copolymerization of (A), (B), (C) and, if appropriate, (D) are in general not critical. The temperatures are, for example, from 60 to 200° C, preferably from 90 to 160° C, and the pressure is, for example, from 1 to 10, preferably from 1 to 3, bar.

Suitable reaction times are, for example, from 0.5 hour to 12 hours, although shorter and longer reaction times are also conceivable.

Suitable solvents are preferably those solvents which are considered to be inert toward anhydrides which are derived from dicarboxylic acids of 3 to 8 carbon atoms, in particular acetone, tetrahydrofuran or 1,4-dioxane. Suitable precipitating agents are aromatic and aliphatic hydrocarbons, for example toluene, ortho-xylene, meta-xylene, para-xylene, ethylbenzene and mixtures of one or more of the abovementioned aromatic hydrocarbons, n-hexane, petroleum ether and isododecane. Mixtures of aromatic and aliphatic hydrocarbons are also suitable.

Preferably, polymerization is effected in the form of a mass polymerization without the addition of organic solvents.

If R⁶ is chosen to be hydrogen, it may be advantageous to add certain amounts, for example from 1 to 30% by weight, based on the mass of all monomers, of water and thus to prevent the formation of crosslinked copolymers.

It is possible to use regulators, for example mercaptoethanol or n-dodecyl mercaptan. Suitable amounts are, for example, from 0.1 to 6% by weight, based on the mass of all monomers.

The copolymerization is advantageously initiated by means of initiators, for example peroxides or hydroperoxides. Examples of peroxides or hydroperoxides are di-tert-butyl peroxide, tert-butyl peroctanoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide, dicyclohexyl peroxodicarbonate. The use of redox initiators is also suitable, and moreover azo compounds, such as 2,2′-azobisisobutyronitrile, 2,2′-azobis(2-methylpropionamidine)dihydrochloride and 2,2′-azobis(4-methoxy-2,4-dimethylvaleronitrile). In general, these initiators are used in amounts of from 0.1 to 20, preferably from 0.2 to 15, % by weight, based on the mass of all monomers.

Polymers are obtained by the copolymerization described above. The resulting polymers may comprise compounds of the formula 1, and they may be subjected to a purification by conventional methods, for example reprecipitation or extractive removal of unconverted monomers. However, the purification can be omitted, and the copolymers described above can be used as a mixture with compound I for the production of leather. If a solvent or precipitating agent has been used, it is possible to remove this after the end of the copolymerization, for example by distilling off.

The polydispersity of the polymers described above is in general from 2 to 10, preferably up to 7, but may assume higher values.

The K values of the polymers described above are from 6 to 100, preferably from 10 to 60 (measured according to H. Fikentscher at 25° C. in, for example, water or tetrahydrofuran and at a polymer concentration of 1% by weight).

The preparation of monomers of the formula I is known per se.

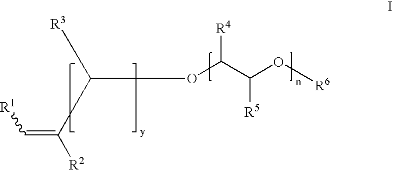

If it is desired to prepare derivatives in which R⁶ is —CO—H (formyl) or —CO—C₁-C₂₀-alkyl or —CO—C₆-C₁₄-aryl, it is advantageous to start from the corresponding derivative in which R⁶ is hydrogen and to react it, for example, with mixed anhydrides or symmetrical anhydrides. Particularly preferred anhydrides are acetic anhydride, benzoic anhydride and H—CO—O—COCH₃.

For carrying out the novel production of leather, it is usual to start from pelts, pickled pelts or semifinished products.

The novel process for the production of leather can be carried out as a process for pretanning or tanning, in which case it is also referred to below as novel tanning process. The novel tanning process starts from hides of animals, for example cattle, pigs, goats or deer, which have been pretreated by conventional methods, i.e. the pelts. With regard to the novel tanning process, it is not important whether the animals were killed, for example by slaughtering, or died of natural causes. The conventional pretreatment methods include, for example, liming, deliming, bating and pickling and mechanical operations, for example the fleshing of the hides.

According to the invention, the polymers described above can consequently be used in the pretanning or tanning. According to the invention, the polymers described above can be used in the retanning.

The novel tanning process is carried out in general in such a way that one or more polymers described above are added in one portion or in a plurality of portions immediately before or during the tanning step. The novel tanning process is preferably carried out at a pH of from 2.5 to 4, it frequently being observed that the pH increases by from about 0.3 to three units while the novel tanning process is being carried out. The pH can also be increased by from about 0.3 to three units by adding basifying agents.

The novel tanning process is generally carried out at from 10 to 45° C., preferably from 20 to 30° C.. A duration of from 10 minutes to 12 hours, preferably from one to three hours, has proven useful. The novel tanning process can be carried out in any desired vessels customary in tanning, for example by drumming in barrels or in rotated drums.

In a variant of the novel tanning process, the polymers described above are used together with one or more conventional tanning agents, for example with chrome tanning agents, mineral tanning agents, syntans, polymer tanning agents or vegetable tanning agents, as described, for example, in Ullmann's Encyclopedia of Industrial Chemistry, Volume A15, pages 259 to 282 and in particular page 268 et seq., 5th Edition (1990), Verlag Chemie Weinheim. The weight ratio of polymers described above or hydrolyzed polymer to conventional tanning agent or the sum of the conventional tanning agents is expediently from 0.01:1 to 100:1. In an advantageous variant of the novel process, only a few ppm of the conventional tanning agents are added to the polymers or hydrolyzed polymers described above. It is particularly advantageous, however, completely to dispense with the admixing of conventional tanning agents.

In a variant of the novel tanning process, polymers described above are added in one portion or in a plurality of portions before or during the pretanning and, in a particular variant, as early as during pickling.

The novel process for the production of leather can preferably be carried out as a process for the retanning of leather using the polymers described above, also referred to below as novel retanning process. The novel retanning process starts from conventionally tanned semifinished products, i.e. for example semifinished products tanned with chrome tanning agents, mineral tanning agents, polymer tanning agents, aldehydes, syntans or resin tanning agents, or semifinished products prepared according to the invention as described above. For carrying out the novel retanning process, the polymers described above are allowed to act on semifinished products.

The novel retanning process can be carried out under otherwise conventional conditions. Expediently, one or more, i.e. for example from 2 to 6, soaking steps are chosen, and washing with water can be effected between the soaking steps. The temperature during the individual soaking steps is in each case from 5 to 60° C., preferably from 20 to 45° C.. Expediently, further compositions usually used during the retanning, for example fatliquors, polymer tanning agents and fatliquoring agents based on acrylate and/or methacrylate, retanning agents based on resin and vegetable tanning agents, fillers, leather dyes or emulsifiers, are employed.

A further aspect of the present invention relates to aqueous dispersions and solutions comprising the polymers described above. In the context of the present invention, dispersions are to be understood as meaning, for example, emulsions or suspensions of the polymers described above. The novel aqueous dispersions and the novel aqueous solutions usually comprise from 20 to 50% by weight of the novel polymers. Their pH is usually from 3 to 10, preferably from 4 to 8.

A further aspect of the present invention relates to leathers produced by the novel tanning process or the novel retanning process or by a combination of novel tanning process and novel retanning process. The novel leathers are-of generally advantageous quality; for example, they are particularly soft. The novel leathers comprise the polymers described above or the hydrolyzed polymers described above in a particularly uniform distribution over the cross section.

A further aspect of the present invention relates to the use of the novel leathers for the production of articles of clothing, pieces of furniture or automotive parts. In the context of the present invention, examples of articles of clothing are jackets, pants, shoes, belts and suspenders. In association with the present invention, examples of pieces of furniture are those pieces of furniture which comprise components of leather. Examples are seating furniture, such as seats, chairs and sofas. Examples of automotive parts are automobile seats.

A further aspect of the present invention relates to articles of clothing comprising the novel leathers or produced from novel leathers. A further aspect of the present invention relates to pieces of furniture comprising the novel leathers or produced from novel leathers. A further aspect of the present invention relates to automotive parts comprising the novel leathers or produced from novel leathers.

A further aspect of the present invention relates to polymers obtainable by copolymerizing
(A) at least one ethylenically unsaturated mono- or dicarboxylic acid of 3 to 8 carbon atoms or at least one anhydride derived from a mono- or dicarboxylic acid of 3 to 8 carbon atoms,
(B) at least one vinylaromatic compound,
(C′) at least one alkoxylated unsaturated ether of the formula I a 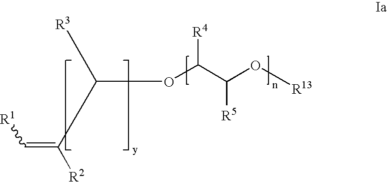
(D) optionally further monoethylenically unsaturated monomers,

where, in formula 1, the variables are defined as follows:
R¹, R² and R³ are identical or different and are selected from C₁-C₄-alkyl and hydrogen;
R⁴ and R⁵ are in each case identical or different and are selected from C₁-C₄-alkyl and hydrogen;
R¹³ is selected from hydrogen, SO₃M, PO₃M₂, CO—H (formyl), —CO—C₁-C₂₀-alkyl and —CO—C₆-C₁₄-aryl,
M is an alkali metal or NH₄⁺ or CH₃,
n is an integer from 3 to 100 and
y is an integer from 0 to 10.

In an embodiment, the novel polymers comprise monomers copolymerized in the polymer in the following proportions:
(A) from 2 to 50, preferably from 5 to 30, % by weight of at least one ethylenically unsaturated mono- or dicarboxylic acid of 3 to 8 carbon atoms or of at least one anhydride derived from a mono- or dicarboxylic acid of 3 to 8 carbon atoms,
(B) from 5 to 80, preferably from 8 to 50, % by weight of at least one vinylaromatic compound,
(C′) from 10 to 90, preferably from 40 to 75, % by weight of at least one alkoxylated unsaturated ether of the formula I a,
(D) from 0 to 20, preferably up to 10, % by weight of at least one further monomer,
the monomers being defined as above.

The monomer or monomers (D) which can optionally be incorporated in the form of polymerized units in the polymers used in the novel process differ from (A). Examples of preferred monomers (D) are:

Ethylenically unsaturated C₃-C₈-carboxylic acid derivatives of the formula II

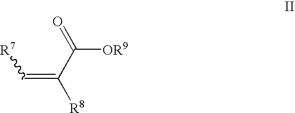

acrylamides of the formula III

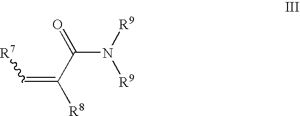

acyclic amides of the formula IV a and cyclic amides of the formula IV b

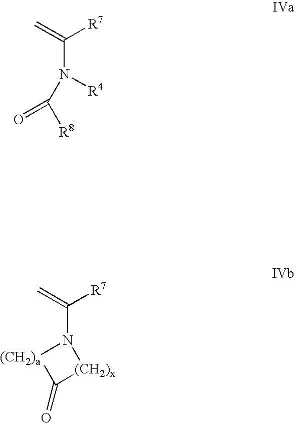

C₁-C₂₀-alkyl vinyl ethers, such as methyl vinyl ether, ethyl vinyl ether, n-propyl vinyl ether, isopropyl vinyl ether, n-butyl vinyl ether, isobutyl vinyl ether, 2-ethylhexyl vinyl ether or n-octadecyl vinyl ether;

N-vinyl derivatives of nitrogen-containing aromatic compounds, preferably N-vinylimidazole, 2-methyl-1-vinylimidazole, N-vinyloxazolidone, N-vinyltriazole, 2-vinylpyridine, 4-vinylpyridine, 4-vinylpyridine N-oxide, N-vinylimidazoline or N-vinyl-2-methylimidazoline,

alkoxylated unsaturated ethers of the formula V,

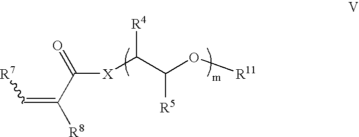

esters and amides of the formula VI,

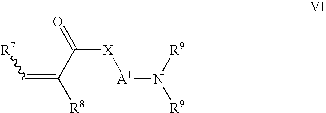

unsaturated esters of the formula VII

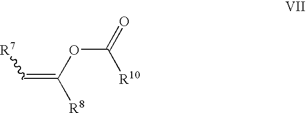

monomers containing sulfonate, phosphate or phosphonate groups,

the variables being defined as above.

The preparation of the novel polymers can be carried out as follows. It is possible to copolymerize the monomers (A), (B), (C′) and, if appropriate, (D) with one another by solution polymerization, precipitation polymerization or, preferably, in the absence of a solvent by mass polymerization. (A), (B), (C′) and, if appropriate, (D) can be copolymerized in the form of random copolymers or as block copolymers.

Pressure and temperature conditions for a copolymerization of (A), (B) (C′) and, if appropriate, (D) are generally not critical. The temperatures are, for example, from 60 to 200° C., preferably from 90 to 160° C., and the pressure is, for example, from 1 to 10, preferably from 1 to 3, bar.

Suitable reaction times are, for example, from 0.5 hour to 12 hours, although shorter and longer reaction times are also conceivable.

Suitable solvents are preferably those solvents which are considered to be inert toward anhydrides which are derived from dicarboxylic acids of 3 to 8 carbon atoms, in particular acetone, tetrahydrofuran or 1,4-dioxane. Suitable precipitating agents are aromatic and aliphatic hydrocarbons, for example toluene, ortho-xylene, meta-xylene, para-xylene, ethylbenzene and mixtures of one or more of the abovementioned aromatic hydrocarbons, n-hexane, petroleum ether and isododecane. Mixtures of aromatic and aliphatic hydrocarbons are also suitable.

Preferably, polymerization is effected in the form of a mass polymerization without the addition of organic solvents.

If R¹³ is chosen to be hydrogen, it may be advantageous to add certain amounts, for example from 1 to 30% by weight, based on the mass of all monomers, of water and thus to prevent the formation of crosslinked copolymers.

It is possible to use regulators, for example mercaptoethanol or n-dodecyl mercaptan. Suitable amounts are, for example, from 0.1 to 6% by weight, based on the mass of all monomers.

The copolymerization is advantageously initiated by means of initiators, for example peroxides or hydroperoxides. Examples of peroxides or hydroperoxides are di-tert-butyl peroxide, tert-butyl peroctanoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide, dicyclohexyl peroxodicarbonate. The use of redox initiators is also suitable, and moreover azo compounds, such as 2,2′-azobisisobutyronitrile, 2,2′-azobis(2-methylpropionamidine) dihydrochloride and 2,2′-azobis(4-methoxy-2,4-dimethylvaleronitrile). In general, these initiators are used in amounts of from 0.1 to 20, preferably from 0.2 to 15, % by weight, based on the mass of all monomers.

By means of the copolymerization described above, novel polymers are obtained. The novel polymers may comprise compounds of the formula I a, and it is possible to subject the novel polymers to a purification by conventional methods, for example reprecipitation or extractive removal of unconverted monomers. However, the purification can be omitted, and the copolymers described above can be used as a mixture with compound I a for the production of leather. If a solvent or precipitating agent was used, it is possible to remove this after the end of the copolymerization, for example by distilling off.

The polydispersity of the novel polymers is in general from 2 to 10, preferably up to 7, but may assume higher values.

The K values of the novel polymers are from 6 to 100, preferably from 10 to 60 (measured according to H. Fikentscher at 25° C. in, for example, water or tetrahydrofuran and at a polymer concentration of 1% by weight).

The preparation of monomers of the formula I is known per se.

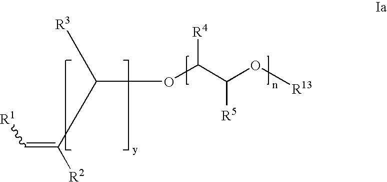

If it is desired to prepare derivatives in which R¹³ is —CO—H (formyl) or —CO—C₁-C₂₀-alkyl, it is advantageous to start from the corresponding derivative in which R¹³ is hydrogen and to react it, for example, with mixed anhydrides or symmetrical anhydrides; preferred anhydrides are, for example, acetic anhydride, benzoic anhydride and H—CO—O—COCH₃.

The novel polymers or the novel aqueous dispersions can be particularly readily used for leather production under the conditions described above.

The working examples which follow illustrate the invention.

1. Synthesis Method for the Polymerization

The K values of the polymers are determined according to H. Fikentscher, Cellulose-Chemie, 13 (1932), 58-64 and 761-774, in aqueous solution at 25° C. and at a polymer concentration of 1% by weight.

Unless stated otherwise, all reactions were carried out under a nitrogen atmosphere.

1.1. Polymer P 1

249 g (0.52 mol) of allyl ether ethoxylate of the formula I.1

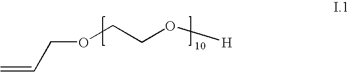

having an average molecular weight M_{w} of 482 g/mol were heated to 100° C. while stirring. At 100° C., a solution of 6.7 g of tert-butyl peroctanoate in 10 g of dipropylene glycol, 36 g (0.50 mol) of acrylic acid and 52 g (0.5 mol) of styrene were simultaneously added dropwise in the course of five hours. The reaction mixture thus obtained was then stirred for 90 minutes at 100° C., a clear oil forming. The oil was taken up in 337 ml of water and brought to pH 6-7 with 63 g of a 25% by weight sodium hydroxide solution.

A 50% strength by weight low-viscosity solution of the polymer P 1 having a K value of 15 was obtained.

1.2. Polymer P 2

373.5 g (0.77 mol) of allyl ether ethoxylate of the formula I.1

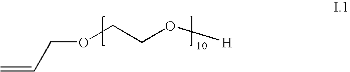

having an average molecular weight M_{w} of 482 g/mol and 78 g (0.77 mol) of acetic anhydride were heated to 150° C. while stirring and kept at 150° C. for one hour. A solution of 12.75 g of di-tert-butyl peroxide in 55 g of dipropylene glycol, 108 g (1.50 mol) of acrylic acid and 156 g (1.5 mol) of styrene were then simultaneously added dropwise at 150° C. in the course of five hours. The reaction mixture thus obtained was then stirred for 90 minutes at 150° C., a clear oil forming. The oil was taken up in 675 ml of water and brought to pH 6-7 with 142 g of a 25% by weight sodium hydroxide solution.

A 50% strength by weight low-viscosity solution of novel polymer P 2 having a K value of 28 was obtained.

1.3. Polymer P 3

273.5 g (0.77 mol) of allyl ether ethoxylate of the formula I.1

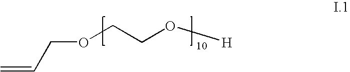

having an average molecular weight M_{w} of 498 g were heated to 150° C. while stirring. At 150° C., the following were simultaneously added dropwise in the course of five hours:

a solution of 13.2 g of di-tert-butyl peroxide in 50 g of dipropylene glycol,

54 g (0.75 mol) of acrylic acid and

234 g (2.25 mol) of styrene.

The reaction mixture thus obtained was then stirred for 90 minutes at 150° C., a clear oil forming. The oil was taken up in 670 ml of water and brought to pH 6-7 with a 25% by weight sodium hydroxide solution.

A 50% strength by weight low-viscosity solution of polymer P 3 having a K value of 18 was obtained.

2. Use Examples

In the case of reagents, data in % by weight are based on shaved weight, unless stated otherwise.

2.1. Preparation of Upper Leather

Two commercial cattle wetblues (from Packer, USA) were shaved to a thickness of 1.8-2.0 mm. The core region was cut into four strips of about 1200 g each. 2% by weight of sodium formate, 10 minutes later 0.4% by weight of NaHCO₃ and a further 10 minutes later 1% by weight of a naphthalenesulfonic acid/formaldehyde condensate, prepared according to U.S. Pat. No. 5,186,846, example “Dispersant 1”, were then added to the strips in a drum (50 l) and with a liquor length of 200% by weight. After 90 minutes, the liquor was discharged. The strips were then distributed over separate drums 1 to 4 for drumming.

Together with 100% by weight of water, 1% by weight each of a 50% by weight (solids content) aqueous solution of dyes was metered into drums 1 to 4 at 25-35° C., the solids of such solution having the following composition:

70 parts by weight of dye from EP-B 0 970 148, example 2.18,

30 parts by weight of Acid Brown 75 (iron complex), Color Index 1.7.16,

and drumming was then effected for 10 minutes in the drum.

4% by weight each of polymer (retanning agent) according to table 1 were then added as stated in table 1, followed by 4% by weight of sulfone tanning agent from EP-B 0 459 168, example K1, and 2% of resin tanning agent Relugan® DLF, commercially available from BASF Aktiengesellschaft. The strips were then drummed for 45 minutes at 15 revolutions per minute in the drum. 3% by weight of vegetable tanning agent Mimosa®, commercially available from BASF Aktiengesellschaft, were then added. After 30 minutes, a further 2% by weight of the dye mixture designated above were metered in.

Acidification to a pH of 3.6-3.8 was then effected with formic acid. After 20 minutes, the liquors were evaluated by an optical method with regard to the exhaustion and were discharged. The leathers were then washed with 200% by weight of water. Finally, 5% by weight of Lipodermlicker® CMG and 2% by weight of Lipodermlicker® PN were metered in 100% of water at 50° C. After a drumming time of 45 minutes, acidification was effected with 1% by weight of formic acid.

The washed leathers were dried, staked and evaluated according to the test criteria specified in table 3. The evaluation was carried out according to a rating system from 1 (very good) to 5 (poor).

Polymer V 1 was a random acrylic acid/acrylamide copolymer having a Fikentscher K value of 70 (1% by weight solution in water), comonomer ratio in mol%: (acrylic acid:acrylamide) 90:10.

TABLE 1
Performance characteristics of the novel leathers 2.1.1 to 2.1.3 and of the
comparative leather V 2.1.4

| | | | | | | | Complete | |
|---|---|---|---|---|---|---|---|---|
| | | | | | Grain | Liquor | dyeing | |
| Drum | Polymer | Leather | Body | Softness | tightness | exhaustion | (section) | Levelness |
| 1 | P1 | 2.1.1 | 2 | 3 | 2 | 3 | 3 | 2-3 |
| 2 | P2 | 2.1.2 | 1-2 | 2 | 1-2 | 2-3 | 2 | 2 |
| 3 | P3 | 2.1.3 | 2 | 2-3 | 1-2 | 2 | 2-3 | 1-2 |
| 4 | V1 | V 2.1.4 | 3 | 3 | 4 | 4 | 4 | 3 |

2.2 Chromium-Free Production of Furniture Leather

A Southern German cattle hide was converted into a wet white semifinished product with (based on the pickled pelt) 1.25% by weight of glutaraldehyde and 3% by weight of the sulfone tanning agent from EP-B 0 459 168, example K1. After the pretanning, the pH was 3.9. After partial drying, the semifinished products were shaved to a thickness of 1.2 mm and cut into strips of about 350 g each.

In separate drums, the following reagents were added to the strips:

100% by weight of water,

6% by weight of the sulfone tanning agent from EP-B 0 459 168, example K1,

4% by weight of vegetable tanning agent TaraO (BASF Aktiengesellschaft),

2.5% of resin tanning agent Relugan S(D (BASF Aktiengesellschaft)

and 1.5% by weight of the dye according to example 4.18 from EP-BI 0 970 148

and drumming was then effected for 60 minutes at 25-30° C. at 10 revolutions per minute.

Thereafter, a pH of 3.6 was established with formic acid and, after 20 minutes, the liquor was discharged.

5% by weight of polymer (retanning agent) according to table 2 were metered into the fresh liquor (water, 100% by weight), followed by

6% by weight of the commercial fatliquoring agent Lipodermlicker® CMG from BASF Aktiengesellschaft,

1% by weight of Lipamin® OK

and 1.5% by weight of the dye according to example 4.18 from EP-BL 0 970 148.

After a drumming time of a further 60 minutes, a pH of 3.2 was established with formic acid, samples of the liquor were taken and the liquor was discharged. The leathers were washed twice with 100% of water each time, stored moist overnight, partly dried and then dried on toggle frames at 50° C. After staking, the leathers were evaluated as below.

The evaluation was carried out according to a rating system from 1 (very good) to 6 (inadequate). The evaluation of the liquor exhaustion was carried out visually according to the criteria of residual dye (extinction) and turbidity.

TABLE 2
Performance characteristics of the novel leathers 2.2.1 to 2.2.3 and of the comparative
leather V 2.2.4

| | | | Leather properties | | | | | | |
|---|---|---|---|---|---|---|---|---|---|
| | | | | | | Color | | Complete | Other |
| Experiment | | Retanning | | | Grain | intensity | Levelness | dyeing | Liquor |
| No. | Drum | agent | Body | Softness | tightness | (dyeing) | Dyeing | (section) | exhaustion |
| 2.2.1 | 1 | P1 | 3 | 3 | 2-3 | 2 | 1 | 2 | 2-3 |
| 2.2.2 | 2 | P2 | 2 | 2-3 | 1 | 1 | 1-2 | 1-2 | 1-2 |
| 2.2.3 | 3 | P3 | 2 | 3 | 2 | 1 | 1 | 1-2 | 2 |
| V2.2.4 | 4 | V1 | 4 | 3 | 4 | 3 | 3 | 4 | 4 |

The furniture leathers produced according to the invention had excellent body and grain tightness with excellent dye dispersing and fixing. Furthermore, it was observed that, as a result of the novel retanning process, tanning assistants were more uniformly distributed in the leather and the exhaustion was improved; tanning agents, in particular the dyes, which were supplied were therefore better utilized. Moreover, it was possible to reduce the wastewater pollution correspondingly.

1. A process for the production of leather, wherein pelts, pickled pelts or semifinished products are treated with at least one polymer which is obtained by copolymerizing
(A) at least one ethylenically unsaturated mono- or dicarboxylic acid of 3 to 8 carbon atoms or at least one anhydride derived from a mono- or dicarboxylic acid of 3 to 8 carbon atoms,
(B) at least one vinylaromatic compound,
(C) at least one alkoxylated unsaturated ether of the formula I 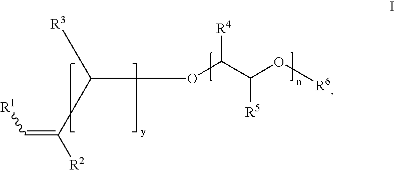
(D) optionally further monoethylenically unsaturated monomers,
where, in formula I, the variables are defined as follows:
R¹, R² and R³ are identical or different and are selected from C₁-C₄-alkyl and hydrogen;
R⁴ and R⁵ are in each case identical or different and are selected from C₁-C₄-alkyl and hydrogen;
R⁶ is selected from hydrogen, SO₃M, PO₃M₂, C₁-C₃₀-alkyl, CO—H (formyl), CO—C₁-C₂₀-alkyl and CO—C₆-C₁₄-aryl,
M is an alkali metal or NH₄+ or CH₃,
n is an integer from 3 to 100, and
y is an integer from 0 to 10.

2. The process according to claim 1, wherein the monomers are comprised in the polymer in the following proportions:
(A) from 2 to 50% by weight of at least one ethylenically unsaturated mono- or dicarboxylic acid of 3 to 8 carbon atoms or of at least one anhydride derived from a mono- or dicarboxylic acid of 3 to 8 carbon atoms,
(B) from 5 to 80% by weight of at least one vinylaromatic compound,
(C) from 10 to 90% by weight of at least one alkoxylated unsaturated ether of the formula I, and
(D) from 0 to 20% by weight of at least one further monomer.

3. The process according to claim 1, wherein (B) is styrene.

4. The process according to claim 1, wherein (A) is (meth)acrylic acid or maleic anhydride.

5. The process according to claim 1, wherein (D) is selected from:
ethylenically unsaturated C₃-C₈-carboxylic acid derivatives of the formula II 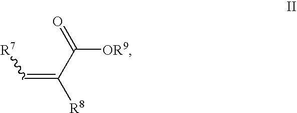
acrylamides of the formula III 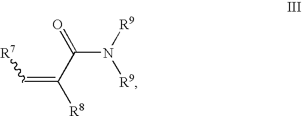
acyclic amides of the formula IV a or cyclic amides of the formula IV b 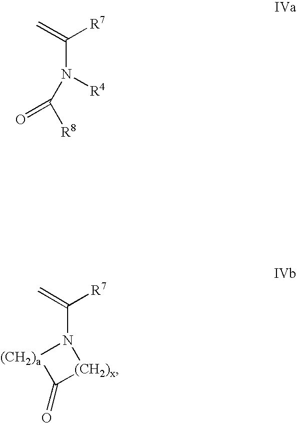
C₁-C₂₀-alkyl vinyl ethers,
N-vinyl derivatives of nitrogen-containing aromatic compounds,
alkoxylated unsaturated esters of the formula V 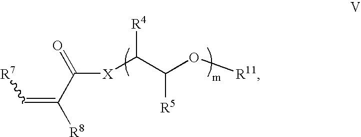
esters or amides of the formula VI 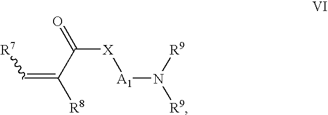
unsaturated esters of the formula VII 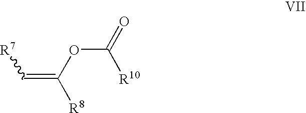
and
monomers containing sulfonate, phosphate or phosphonate groups,
in the formulae II to VII the variables being defined as follows:
R⁷ and R8 are identical or different and are selected from hydrogen and C₁-C₁₀-alkyl,
R⁹ is identical or different and is selected from hydrogen and C₁-C₂₂-alkyl,
A¹ is branched or straight-chain C₂-C₆-alkylene,
x is an integer from 2 to 100,
a is an integer from 0 to 6,
m is an integer from 2 to 200,
R¹⁰ and R¹¹ are identical or different and are selected from hydrogen and C₁-C₁₀-alkyl,
X is oxygen or N—R¹²,
R¹² is selected from hydrogen, C₁-C₁₀-alkyl and phenyl,
and the remaining variables are defined as above.

6. The process according to claim 1, wherein the polymers are metered as an aqueous dispersion or solution.

7. A leather produced by a process according to claim 1.

8. (canceled)

9. An article of clothing produced from or comprising a leather according to claim 7.

10. A piece of furniture produced from or comprising a leather according to claim 7.

11. An automotive part produced from or comprising a leather according to claim 7.

12. A polymer obtained by copolymerizing:
(A) at least one ethylenically unsaturated mono- or dicarboxylic acid of 3 to 8 carbon atoms or at least one anhydride derived from a mono- or dicarboxylic acid of 3 to 8 carbon atoms,
(B) at least one vinylaromatic compound,
(C′) at least one alkoxylated unsaturated ether of the formula I a 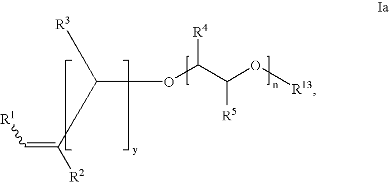
(D) optionally further monoethylenically unsaturated monomers,
where, in formula I a, the variables are defined as follows:
R¹, R² and R³ are identical or different and are selected from C₁-C₄-alkyl and hydrogen,
R⁴ and R⁵ in each case are identical or different and are selected from C₁-C₄-alkyl and hydrogen,
R¹⁴ is selected from hydrogen, SO₃M, PO₃M₂, CO—H (formyl), CO—C₁-C₂₀-alkyl and CO—C₆-C₁₄-aryl,
M is an alkali metal or NH₄⁺ or CH₃,
n is an integer from 3 to 100, and
y is an integer from 0 to 10.

13. The polymer according to claim 12, wherein the monomers are comprised in the polymer in the following proportions:
(A) from 2 to 50% by weight of at least one ethylenically unsaturated mono- or dicarboxylic acid of 3 to 8 carbon atoms or of at least one anhydride derived from a mono- or dicarboxylic acid of 3 to 8 carbon atoms,
(B) from 5 to 80% by weight of at least one vinylaromatic compound,
(C′) from 10 to 90% by weight of at least one alkoxylated unsaturated ether of the formula I a, and
(D) from 0 to 20% by weight of at least one further monomer.

14. The polymer according to claim 12, wherein (D) is selected from
ethylenically unsaturated C₃-C₈-carboxylic acid derivatives of the formula II 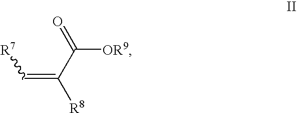
acrylamides of the formula III 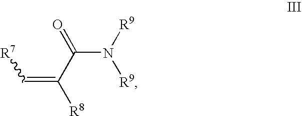
acyclic amides of the formula IV a or cyclic amides of the formula IV b 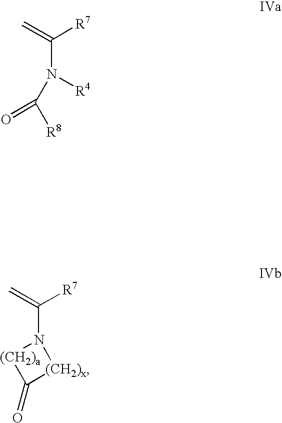
C₁-C₂₀-alkyl vinyl ethers,
N-vinyl derivatives of nitrogen-containing aromatic compounds,
alkoxylated unsaturated esters of the formula V 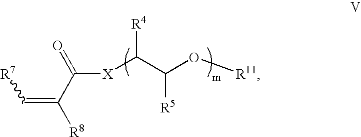
esters or amides of the formula VI 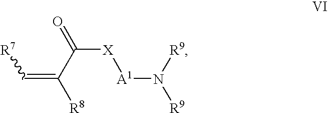
unsaturated esters of the formula VII 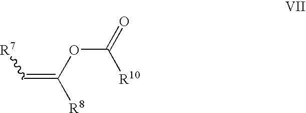
and
monomers containing sulfonate, phosphate or phosphonate groups,
where, in the formulae II to VII, the variables are defined as follows:
R⁷and R⁸ are identical or different and are selected from hydrogen and C1-C10-alkyl,
R⁹ is identical or different and is selected from hydrogen and C₁-C₂₂-alkyl,
A¹ is branched or straight-chain C₂-C₆-alkylene,
x is an integer from 2 to 100,
a is an integer from 0 to 6,
m is an integer from 2 to 200,
R¹⁰ and R¹¹ are identical or different and are selected from hydrogen and C₁-C₁₀-alkyl,
X is oxygen or N—R¹²,
R¹² is selected from hydrogen, C₁-C₁₀-alkyl and phenyl,
and the remaining variables are defined as above.

15. A process for the preparation of polymers according to claim 12 by copolymerizing:
(A) at least one ethylenically unsaturated mono- or dicarboxylic acid of 3 to 8 carbon atoms or at least one anhydride derived from a mono- or dicarboxylic acid of 3 to 8 carbon atoms,
(B) at least one vinylaromatic compound,
(C) at least one alkoxylated unsaturated ether of the formula I a,
(D) and, if required, at least one further monomer.

16. An aqueous dispersion comprising up to 50% by weight of at least one polymer according to claim 12.
